(19) United States
(12) Patent Application Publication
(10) Pub. No.: US 2006/0174350 A1
(43) Pub. Date: Aug. 3, 2006

(54) Methods and apparatus for optimizing identity management

(75) Inventors: Stefan Roever, Los Altos Hills, CA (US); Kevin Collins, Cupertino, CA (US); Alex F. Clark, San Jose, CA (US); James Bruce, Scotts Valley, CA (US)

Correspondence Address: BEYER WEAVER & THOMAS LLP, P.O. BOX 70250, OAKLAND, CA, 94612-0250, US

(73) Assignee: Navio Systems, Inc.

(21) Appl. No.: 11/118,608

(22) Filed: Apr. 29, 2005

Related U.S. Application Data
(60) Provisional application No. 60/649,929, filed on Feb. 3, 2005.

(51) Int. Cl. H04L 9/32

(52) U.S. Cl. 726/27

(57) ABSTRACT

Methods and apparatus are describe for providing access to identity information corresponding to a first entity. The identity information includes a plurality of identity components stored in a distributed manner. A first identity access title object is generated which is operable to confer rights to access first selected ones of the identity components to a presenter of the first identity access title object. The first identity access title object is transmitted to a second entity. Access to the first selected identity components is facilitated in response to presentation of the first identity access title object by the second entity.

### RELATED APPLICATION DATA

This application claims priority under 35 U.S.C.119(e) of U.S. Provisional Patent Application No. 60/649,929 filed Feb. 3, 2005 (Attorney Docket No. NAV1P005P), the entire disclosure of which is incorporated herein by reference for all purposes.

### BACKGROUND OF THE INVENTION

The Internet has become an efficient mechanism for globally distributing digital content, such as documents, pictures, music, electronic business cards, and other types of digital content. Information can now be transmitted directly and instantly across the Internet from the content owner to the content buyer, without having to first convert it into physical form, such as paper documents, compact disks, photographs, etc.

However, organizations and individuals are burdened with insecure and inefficient methods for sharing digital content (i.e., electronic mail, instant messenger, peer-to-peer, hyperlinks shared via electronic mail, instant messenger, etc.). In particular, there is no effective and standard way for an organization or user to share a digital identity, such as an electronic business card.

Digital identity information tends to become stale or outdated quickly, once shared with another organization or individual, since it cannot be easily updated. In general, there is no optimal way to dynamically update a transmitted digital identity short of retransmission. In addition, there is also no effective way to share only a certain portion of a digital identity to a particular entity. For example, a digital identity may comprise sensitive medical information and non-sensitive contact information. Currently, if both are part of the same digital identity, there is no optimal and open way to insure that the medical information is not divulged when sharing the contact information.

What are needed are methods and apparatus for optimizing identity management.

### SUMMARY OF THE INVENTION

The present invention provides techniques for managing the identity of an entity in a computer network. According to specific embodiments, methods and apparatus are provided for providing access to identity information corresponding to a first entity. The identity information includes a plurality of identity components stored in a distributed manner. A first identity access title object is generated which is operable to confer rights to access first selected ones of the identity components to a presenter of the first identity access title object. The first identity access title object is transmitted to a second entity. Access to the first selected identity components is facilitated in response to presentation of the first identity access title object by the second entity.

According to other specific embodiments, A network for managing identity information for each of a plurality of entities is provided. A distributed data store stores the identity information. The identity information for each entity includes a plurality of identity components. An identity management component enables each entity to selectively manage access to subsets of the corresponding identity components by others of the entities. A title publishing component generates title objects each of which is operable to confer rights to access selected ones of the identity components of an associated entity to presenters of the title object. A title resolver component facilitates access to the selected identity components in response to presentation of the title object.

A further understanding of the nature and advantages of the present invention may be realized by reference to the remaining portions of the specification and the drawings.

### BRIEF DESCRIPTION OF THE DRAWINGS

FIG. 1 depicts a simplified diagram according to one embodiment of the invention, in which an online contact management system is optimized.

FIG. 2 is a flowchart illustrating a simplified process for managing identity information according to a specific embodiment of the invention.

FIG. 3 is a flowchart illustrating a simplified process in which a digital identity title is used to manage a quote for a service according to a specific embodiment of the invention.

FIG. 4 shows a simplified interface that allows users to manage how they are contacted according to a specific embodiment of the invention.

FIG. 5 is a flowchart illustrating a simplified process for enabling voice based communication with a contact proxy according to a specific embodiment of the invention.

FIG. 6 is a simplified block diagram for illustrating actions that can be carried out on incoming voice and text messages according to a specific embodiment of the invention.

FIG. 7 is a flowchart illustrating a simplified process in which a contact proxy is used for text based messaging according to a specific embodiment of the invention.

FIG. 8 is a flowchart illustrating a simplified process in which user information is provided to another party in a physical form according to a specific embodiment of the invention.

FIG. 9 is a simplified diagram of a digital personal assistant according to a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention is directed to the facilitation of identity management through the use of title objects (also referred to herein simply as titles). A title object is a self-authenticating, digital bearer instrument which expresses rights or permissions to which the holder of the object is entitled. A title object may include a number of elements and attributes including embedded digital content, ownership attributes, copy permissions, and others as described herein. A title can represent the rights to a single piece of digital content or a single resource, or it can represent the rights to a multitude of digital content and resources and in a variety of formats. The digital content rights, such as the ability to exchange or copy, are typically determined by the content publisher. Furthermore, a title can also represent the rights to another title or multitude of titles, which in turn express rights to digital content or resources. In general, embodiments of the present invention may be implemented using title objects and title-enabled systems as described in International Publication No. WO 03/098398 A2 (International Application No. PCT/US03/15614; Attorney Docket No. NAV1P004WO), the entire disclosure of which is incorporated herein by reference for all purposes.

Users can initiate a variety of exchanges with each other depending on the type of title and the rules associated with that title. These exchanges can take the form of trades or transfers. In the case of trades, offers can be reviewed, and then subsequently accepted, canceled, or a counter-offer can be presented. The counter-offer process can continue until satisfaction, or until trade is canceled.

According to some embodiments, a title that corresponds to or is associated with a digital identity refers to a set of identity profiles (i.e., business card, business directory, “yellow pages,” etc.). A profile is a data file that may comprise relevant business and personal information that one user wishes to make available to other users (i.e., name, nickname, title, business address, home address, business contact information, email, etc.).

According to some embodiments, the digital identity owner may distribute a title that includes the digital identity information, but prevents its exchange or copy thereafter. In another embodiment, a digital identity owner may present layers of identity, or digital personas, to others based on an entitlement. For example, information contained in digital identity title may include medical information only available to a medical professional, and business information available to clients and partners. In another embodiment, anonymity may be enforced, if required.

In some implementations, the digital identity owner may distribute a title that includes instructions and/or program logic that allows the recipient to access information stored in a remote computing system. The instructions and program logic can also contain restrictions on what information can be viewed or updated, and when it can be viewed or updated. This allows for access to dynamically changing information about the user and reduces the need to maintain centralized records for synchronization purposes.

According to specific embodiments of the present invention, an individual's digital identity is a “federated” identity in that it comprises a collection of pieces of information or identity components which may be stored in a distributed manner across networks, network devices, mobile devices, smart or secure cards, chips, etc., which may be under the control of disparate entities. This distributed information may correspond to conventional personal information, e.g., first name, last name, middle initial, address, contact information etc.

According to some embodiments, the federated identity may also include a much wider variety of types of information. For example, such information may include (but is not limited to) information representing or corresponding to contracts to which an individual is a party, certifications for which an individual has qualified, communication or computing devices owned by or associated with an individual, other resources associated with the individual (e.g., a vehicle), online transactions in which the individual has engaged, financial accounts held by or financial information associated with the individual (e.g., credit history), an individual's medical history, etc.

According to specific embodiments, entities, e.g., merchants, acquire contracts as a part of doing business and negotiating deals with others in the system. These contracts may themselves be represented by titles that express the terms and conditions of the contract. For example, a merchant might purchase a bundle of contracts giving it the right to conduct transactions using particular credit cards at certain rates and under certain conditions. The merchant would then possess title objects representing these contracts which enable the merchant to operate in the system in the desired manner.

These contract titles then form a part of each merchant's identity, and can be used for additional identity, processing, and financial transactions. The contracts may also serve to add value to an entity's identity during financial transactions. For example, during acquisitions, the contracts become part of the tangible value. The contracts can represent certifications that a merchant has obtained. The certifications provide value in that they can convey trust, level or experience, or other valuable information for people that are evaluating the services of the merchant.

In general, the collection of information or identity components associated with an individual can be thought of as a profile for the individual which can evolve over time and which provides a flexible and granular definition of the individual's identity. And while the term “individual” is used herein, it should be understood that the identity of the present invention may correspond to a wide variety of entities including, for example, all types of natural and legal persons, corporate entities, one or more network devices, one or more software programs, etc.

Access to the various components of an individual's federated identity is controlled by title objects which represent rights to the underlying information. These access rights may be limited in a variety of ways. For example, a title object which grants access to one or more components of an individual's identity may have an expiration date after which the grant of rights expires. In other examples, the identity access rights represented by a title object may be limited with reference to some characteristic of the entity to which the rights are granted. For example, the access rights may only be usable by that entity as long as the entity is able to provide evidence of a current professional certification (which may also be represented by a title object).

According to various embodiments, a digital identity includes both content and control information. Content is the information that may be made available to other entities (i.e., simple contact information, medical history, credit history, etc.). Control information is used by the title-enabled infrastructure in which the invention is enabled to enforce entitlements and access rights (as represented in title objects) held by other entities.

The pieces of information of which an individual's identity is composed may be stored conventionally as, for example, database records. Alternatively, some or all of these pieces of information may be represented by or may themselves be embedded within title objects. Regardless of how the information is represented and stored, the federated identity of the present invention provides the individual a high degree of control and granularity in granting access to various components of his identity.

For example, when filling a prescription online, an individual will likely need to provide another party with specific information including his name and address from one database, and his medication allergies from another. On the other hand, he will not typically need to provide information relating to a contract he has entered with an Internet service provider, or the balance of a particular bank account. Therefore, according to the invention, a title object may be generated and provided to the other party which only grants access to the components of the federated identity which are necessary for the current transaction.

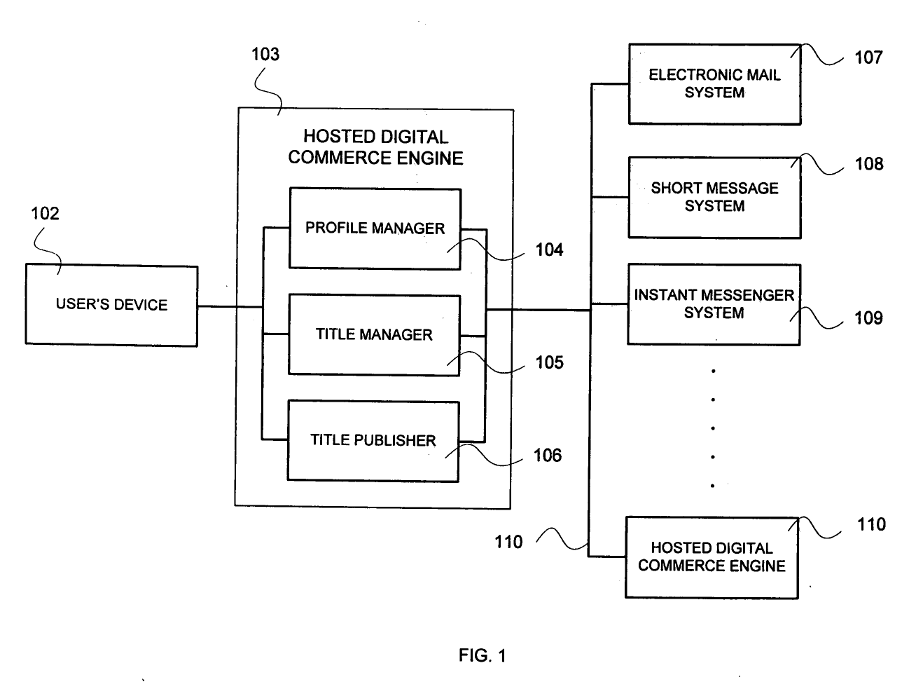

FIG. 1 depicts a simplified diagram of a title-enabled system in which various embodiments of the invention may be implemented. The system includes a user's device 102, a hosted digital commerce engine 103 that supports a profile manager 104, title manager 105, and title publisher 106, as well as an electronic mail system 107, a short message service system 108, instant messenger system 109, and additional hosted digital commerce engine 110. Each of the system elements is coupled to the other using a network protocol 101, such as TCP/IP over the Internet.

It should be noted that the system shown in FIG. 1 is merely exemplary and that a wide variety of network devices and topologies may be employed to implement embodiments of the invention. In particular, it should be noted that the manner and locations in which title objects and/or identity components may be stored and accessed may vary considerably and remain within the scope of the invention. That is, for example, embodiments are contemplated in which such information is stored in a single central repository, and in which such information is stored in a widely distributed manner across networks and devices under the control of disparate entities. Examples of different approaches to generating, storing, managing, and transferring title objects which are within the scope of the invention are described in International Publication No. WO 03/098398 A2 incorporated herein by reference above.

The hosted digital commerce engine 103 (DCE) is intended to depict an example implementation of the invention whereby the DCE hosts the title enabled systems on behalf of consumers that use devices 102 to access the DCE. The title enabled systems include the profile manager 104 that stores and manages the consumers profile information including their contact information, the title manager 105 that stores and manages the consumer's titles, and the title publisher 106 that generates titles for the DCE. In other embodiments of the invention, these title enabled systems may reside independently of each other, or even be integrated into a desktop application.

The electronic mail system 107, short message service system 108, and instant messenger system 109 depict external systems that can be used to transmit and deliver titles to other consumers that may or may not use an online title enabled solution. Each of these systems would transmit Titles using their own network protocols and network systems. For example, an electronic mail system 107 can deliver a title as an attachment to an electronic message using the SMTP protocol. The recipient can retrieve the message using the POP3 protocol, and open the attachment in a title enabled application.

An additional hosted digital commerce engine 110 is shown in FIG. 1 to demonstrate that consumers on separate DCEs can share contact information between each other. In this case the hosted digital commerce engine 110 provides the same title enabled components and service as the first engine 103.

As previously described, a title is an object that may have a number of elements and attributes including embedded digital content, ownership attributes, and copy permissions. In this example, a contact title can redeem a single contact record, such as an electronic business card, or a contact list composed of multiple contact records, as in business directory. The contact record contains information that would be commonly found in a business card, such as full name, company name, address, phone number, email, etc. The contact title comprises as a pointer to the location of the contact record or contact list. That is, it directs the title management system to the specific online profile manager 104 upon which the contact record or contact list resides.

For instance, a contact owner creates a single contact record and stores it on a specific profile manager 104. The owner then requests a contact title, which would then be generated by the title publisher 106 and stored in the title manager 105 for distribution by the contact owner to users. Users could then use the contact title to redeem the latest contact record whenever needed.

The profile manager 104 can store any type and quantity of information on behalf of the user including business, personal, financial, preference, and emergency information. Furthermore, any variation of contact titles can also be generated by the title publisher 106 on behalf of the user. The titles can be any number of tags, tickets, or tokens as deemed necessary by the user. A tag is a title object that can be copied among users, a token is a title object that cannot be copied like a tag, but can be transferred or exchanged between users, and a ticket is a title object that is issued to a specific user, and hence cannot be copied or transferred among users.

For instance, a tag can be published that points to business contact information as described previously. This tag can then be freely copied and distributed to other business recipients. By redeeming the tag, the recipient will only be able to dynamically read the business contact information from the profile. Alternatively, a ticket can be published that points a trusted business associate to financial information. This ticket can be redeemed by the business associate to dynamically read certain financial records within the profile to support the user's business needs. Another example would be to give a ticket to a spouse in order to read and update certain profile records.

According to various implementations, the manner in which a title object representing access to a subset of the components of an individual's federated identity is generated may vary. For example, the process by which such a title object is generated may be automatic or may be directed to some degree by the individual. Where the identity components to which the title object are commonly provided, such a title object may be preexisting. Alternatively, such a title object may be generated on the fly to grant access rights to identity components which may only be relevant for the current transaction.

According to one embodiment, the individual is presented with an interface which provides access to some or all of the components of his federated identity and allows him to select from among these the components to which he is prepared to provide access for a given transaction with another party. In response to selection of some subset of these identity components, a title object is generated which grants access to the selected components, and the title object is then provided to the other party.

According to another embodiment, a title object granting access to components of an individual's federated identity may be generated as part of an “opt in” by the individual to, for example, a marketing campaign which requires specific personal information to be provided as a condition to participation. When a user decides to opt in (e.g., provide permission to another entity to market to them), they are generally required to provide information about themselves. In one embodiment, the user may be required to complete a survey and answer some specific questions that will give a merchant the ability to target their marketing campaigns. The results of the survey are bound and captured in a title object that is then exchanged (in a transaction) with the merchant. The user will receive a “permission” title as part of the exchange but may also receive some other titles as granted by the merchant—as part of a promotion. The “permission” title provides the user with a record that they have opted in and provides them with rights to contact the merchant, update their information, and most importantly opt out of the marketing campaign. Opting out revokes the merchants right to market to the user. As another benefit of titles, the users identity may never be revealed to the merchant and the merchant must redeem a title right in order to communicate with some “blinded” user. Once the user has opted out, the user can be assured that the merchant will never know their identity.

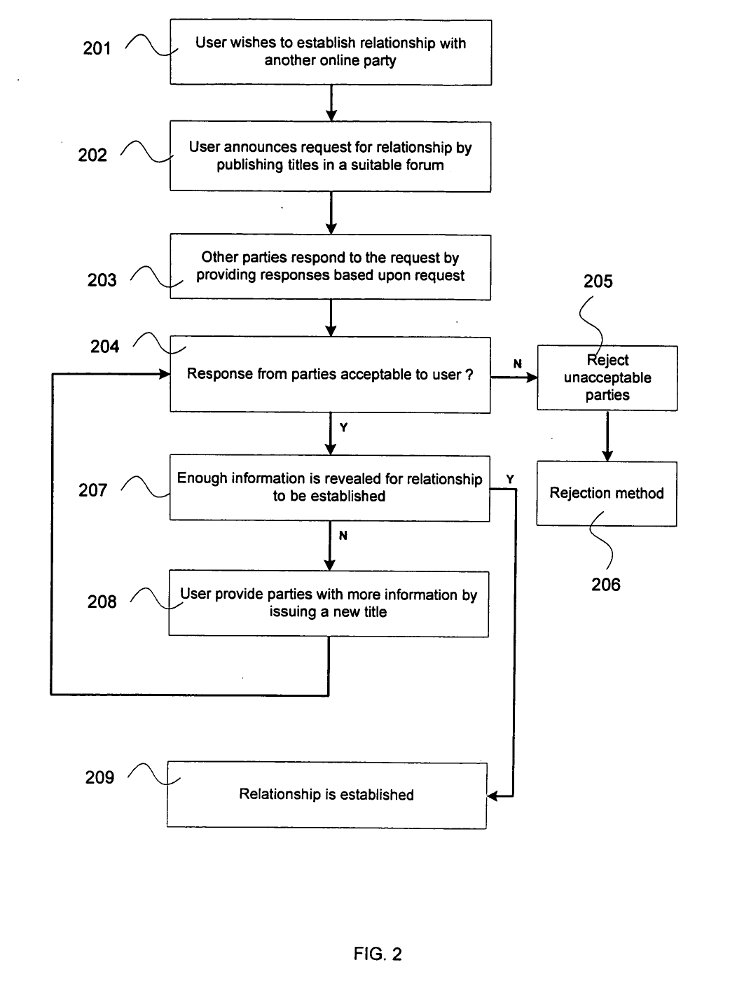

Referring now to FIG. 2, a simplified process that utilizes the user's ability to manage the layers identity that can be presented to another party is shown, according to one embodiment of the invention. In one embodiment, the relationship established between the parties is based such as a contracting or consulting relationship, or a personal relationship as in the case of a mobile dating game.

Initially, the user wishes to establish with another party 201, and announces the request for a relationship by publishing titles that provide access to a small part of the contact record, and describes the basis of the relationship that is going to be established 22. These titles are made available by an appropriate mechanism. In one embodiment, the mechanism includes using a title search engine or a market maker. A market maker may operate an exchange for the sale of titles, perform licensing of content represented by the titles, maintaining a book of trades, closing and clearing trade transactions and performing additional value add as determined by the market.

Parties who respond to this request to establish a relationship reply to the user with the appropriate information 203. The response can either be in the form of a title or other mechanisms such as email, SMS or URL. The user will analyze the responses and will reject the parties that do not meet the requirements 205, using an appropriate rejection method 206. For parties that meet the requirements the user will decide if there is enough information upon which to establish the relationship 207. If there is then the relationship will be established 209. If there is not enough information upon which to establish the relationship then another title is issued that provides more contact information and more requirements 208 and the process is repeated. In another embodiment the decision making processes can be carried out without user intervention using automatic rules based system.

In one such exemplary implementation, an automated process is operable to look up registries in search of information and resources to satisfy a rule (or request) or set of rules. The rules can provide instructions for handling registry lookups and registry responses and then take further action. The rules can define decisions based on the information returned and can investigate further the resources that have been identified. Further investigation can include inspection of contracts and certifications to ensure guarantees, privacy, and competence before establishing a relationship.

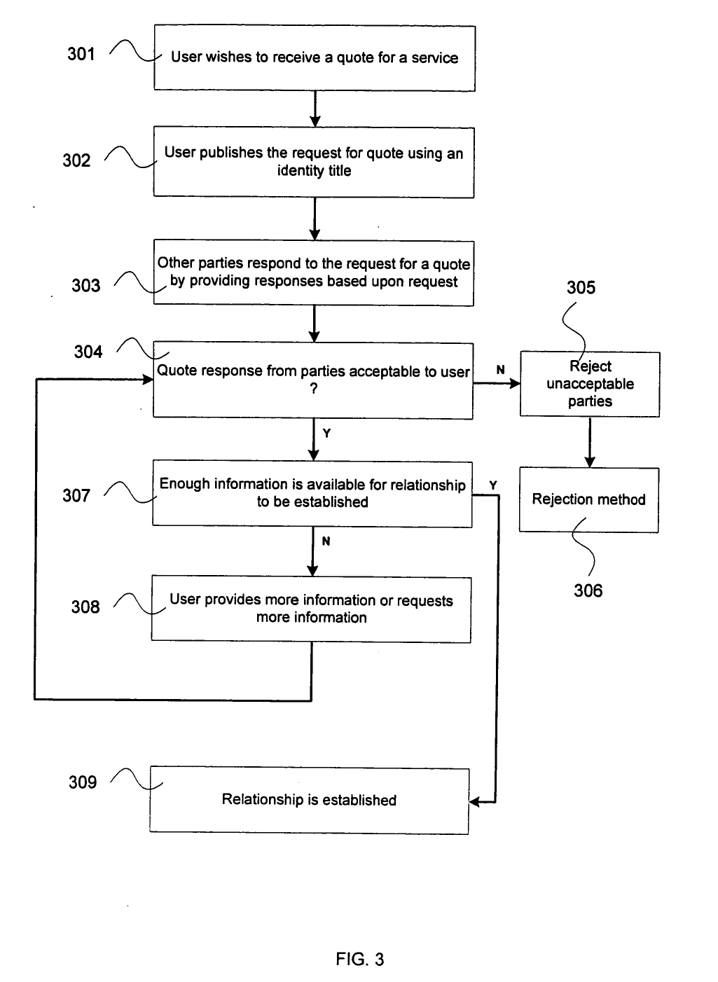

Referring now to FIG. 3, a simplified process of managing layers of identity is shown in which a digital identity title is used to manage a quote for a service such as loans and insurance, according to one embodiment of the invention. Initially, the user wishes to receive a quote for a service 301 and publishes a request for a quote using an identity title 302. The identity title will contain the description of the quote and contact details. Note that the contact details will either be a temporary proxy contact address or will be a title enabled mechanism that only allows the other parties to communicate with user if they have a valid title.

In other embodiments other mechanisms could be used for the communication channel, for example emails that must have a title or a digital signature attached for the email to reach the user. The identity title is posted using a suitable mechanism such that the responding parties can easily find it in one possible embodiment the market maker could be used. When the responding parties find the title and wish to quote for this service, they will respond using the communication method describe in the title 33. The user decides for each response if it is acceptable or not 304, if it is not the unacceptable parties will be rejected 305, and as part of the rejection method the parties ability to communicate with the user will be removed. The mechanism for removing the ability to communicate with the user is dependant on the implementation but in one embodiment the mechanism would be by invalidating the title, or the properties of the title enable only the parties to communicate for a set number of times, or there is a time limit imposed.

For parties with whom the user wishes to carry on the process, the user can then either decide to establish a relationship using normal contact information 307 and provide the appropriate information using a title or another appropriate mechanism 309. If the user decides that they need more information in order to establish the relationship then the user can either use a number of mechanisms to request more information 308. In one embodiment this mechanism could be title based or the communication method that has been established could be used. These iterations will be repeated until the user is willing to establish a relationship.

In another embodiment, the user publishes only a limited identity in the process of identity scoring. Identity scoring is the process of assigning a metric to a user to establish validity. This metric can be based a wide range of measures depending on the context, but the metric could be based upon the credit score, number of titles owned, previous title transactions, title enabled accounts or other measurable criteria that could be established from information that could be extracted from the user's titles and content information. The identity scoring metric can be used by other parties to determine if a user whose identity is hidden is a valid possible customer or not.

The user can establish rules on who can view his identity scoring metrics or who can engage in particular transactions with that user. Rules can be explicit, added based on a formal request process, or even dynamically evaluated based on the identity of the requesting party. For example, the user can indicate that merchants with proper certification and contractual relationship may view the identity scoring metric. In other embodiments, the identity metric or some combination of identity components can be used to facilitate title-enabled transactions were there needs to be some measure of the user's validity when the identity is hidden or obscured.

Allowing individuals to establish rules about who can look at their identity or who can participate in a particular transaction allows trustworthy transactions to be conducted between entities who do not know each other's identities in advance. That is, as long as the relevant components of each party's federated identity conforms to the other party's criteria, the transaction is allowed to proceed. And the transaction might include, for example, one of the parties giving permission to the other party (i.e., in the form of one or more title objects) for accessing specific components of that party's identity.

In another embodiment, a contact proxy is used. Today when a user gives another party their contact details then the party can contact that person at any time when in fact the user wants to control how people contact them. Conversely users may provide contact information to other parties, but the user may wish to be contacted by other means or at another address or phone number.

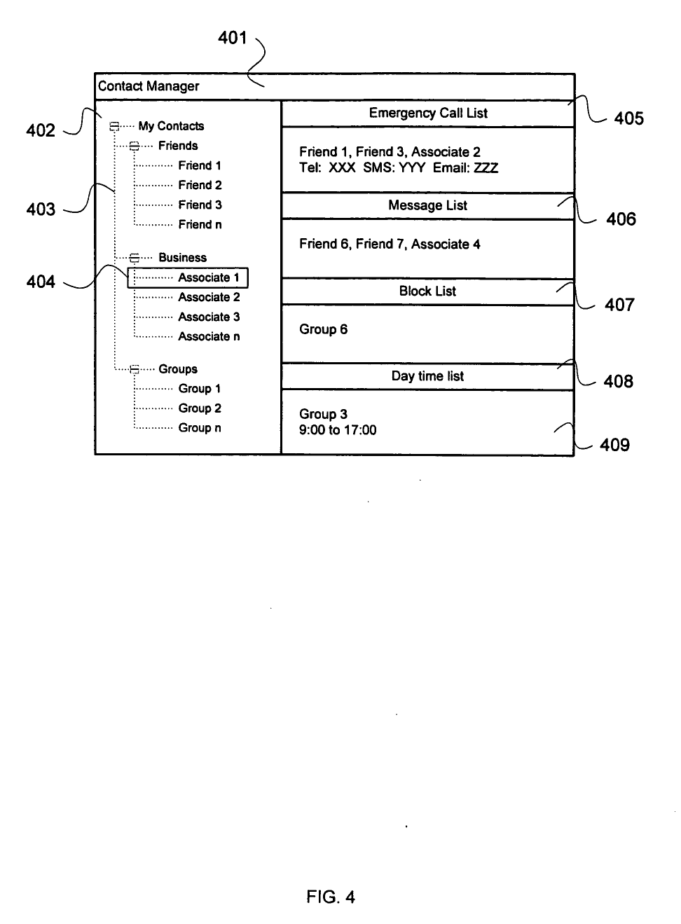

Referring now to FIG. 4, a simplified interface that allows users to manage how they are contacted is shown, according to one embodiment of the invention. Screen contact manager 401 defines how incoming messages are handled. The user's contact titles are listed in one window 402, and are organized and grouped in a directory structure into various categories. For example, associate 1 has been selected 404 and is going to be moved into another window to give that contact their contact rights. The windows emergency call list 405, lists the contacts that have access all the time. In the window the list of contacts with the emergency contact rights and the emergency contact details. The message list 406 list the people who will be sent straight to a messaging system. The block list 407 is a list of contacts that will be totally blocked. The daytime list is the list of contacts that can make contact during the defined hours. In other embodiments there could be other windows which would map the contact rights to a set of rules that are either predefined or used defined, and a list of contact numbers and addresses to which to forward the messages.

In another embodiment, the movement of the contacts to another window invokes redemption rights on the titles that are moved. The redemption rights to be redeemed are identified by the window and automatically invoked. The redemption rights specify the rights, rules and logic to be performed.

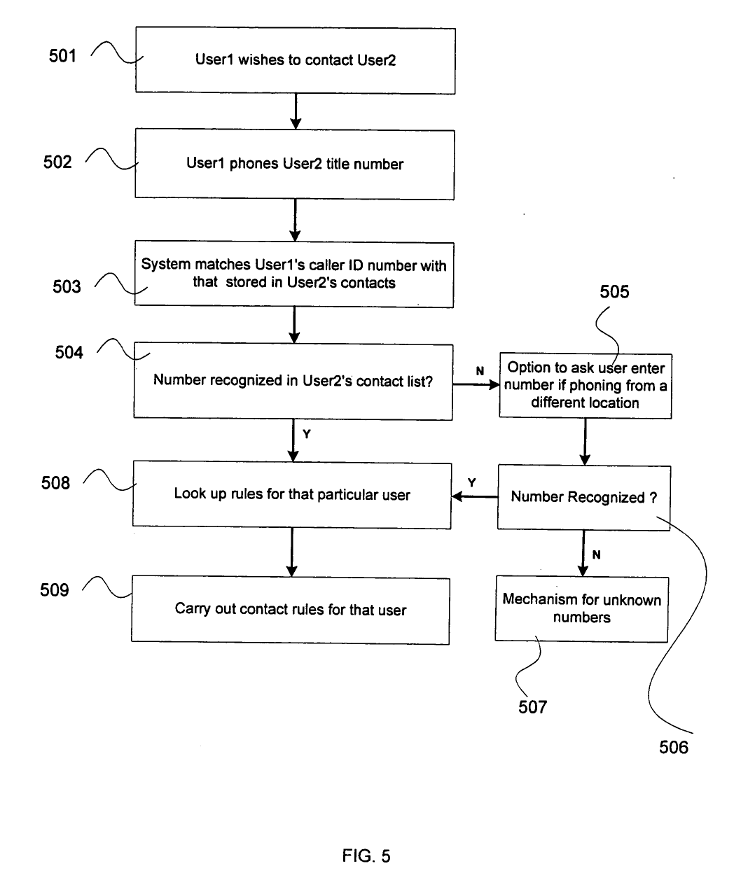

Referring now to FIG. 5, a simplified process of how a contact proxy would function with voice based communication is shown, according to one embodiment of the invention. For example, user1 wishes to contact user2 501, and dials the contact proxy number 502. This phone number in this embodiment is assumed to be a number that is accessible from public networks, though in other embodiments this number may exist within an internal phone network. The phone network described in this embodiment and other embodiments can be PSTN (Public Switched Telephone Network, VOIP (voice over IP), wireless or other appropriate technologies.

When the contact proxy system receives user1's incoming call, the contact proxy system uses the caller ID system to determine the phone number of user1 and matches it with the phone numbers in user2's contact lists 503. In other embodiments of this system other mechanisms could be used to identify the identity of user1 depending upon the voice network technology used, for example SS7 over IP. If the match is not successful 504, or there is not caller ID or equivalent available, then the system will prompt the user to enter an identifying number 55. Embodiments of the identifying number include user1's phone number, a number that user2 could supply to groups of people, or an individual number to each user. If the number is not recognized 506, then the mechanism for handling unknown numbers is used 507, which is defined by the rules set down for the user. For numbers that are recognized 504, 506 then the rules for that contact are carried out 509.

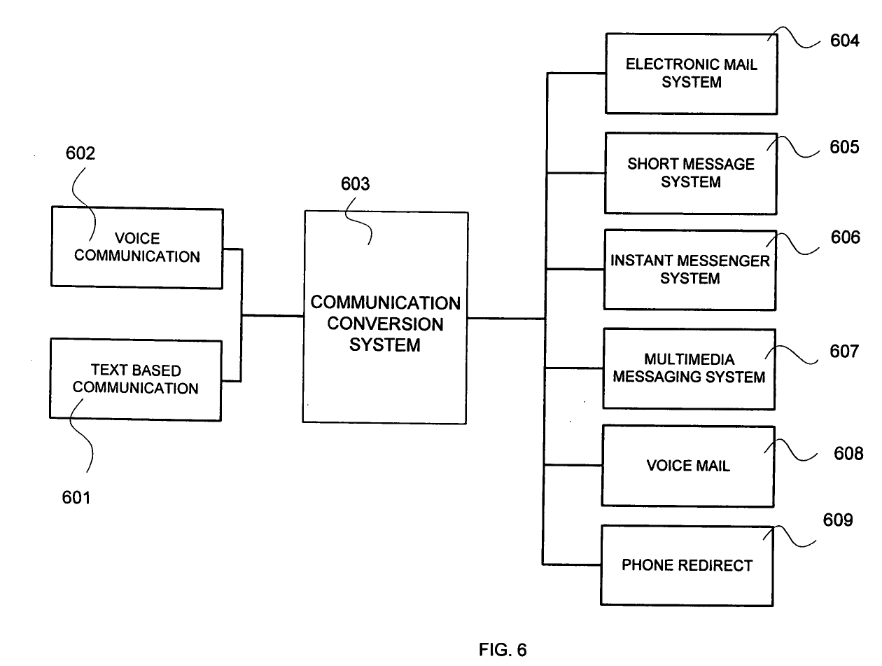

Referring now to FIG. 6, a simplified process of the actions that can be carried out on incoming voice and text messages, according to one embodiment of the invention. Voice based communications 602 (i.e., phone calls, voice messages, etc.) may be converted using the communication conversion system 603 to other audio formats, such as multimedia messaging system 607, redirection to a voice mail system 608, or redirection to another phone number 609. Voice based communications 602 may also be converted to text based formats such as e-mail 604, short message system 605, instant messaging 66, and multimedia messaging system 607. In one embodiment, the voice message is not directly converted, but rather a message may be generated stating that a particular user has left a message.

Text based communication 601 may also be converted by communication conversion system 603 to other text based formats such as e-mail 604, short message system 605, instant messaging 66, and multimedia messaging system 607. Message conversion may be complete or just partial depending on the rules specified by the user. Text based communication 601 may also be converted into voice based communications such as multimedia messaging system 607 or redirection to a voice mail system 608.

In one embodiment, voice communication 602 and text based communication 601 may be converted and sent between multiple systems (e.g., e-mail 604, short message system 605, instant messaging 66, and multimedia messaging system 607) based on user implemented rules. This may allow the user to implement a ubiquitous messaging and contact scheme based upon user rules, expressed by titles, which the user imposes.

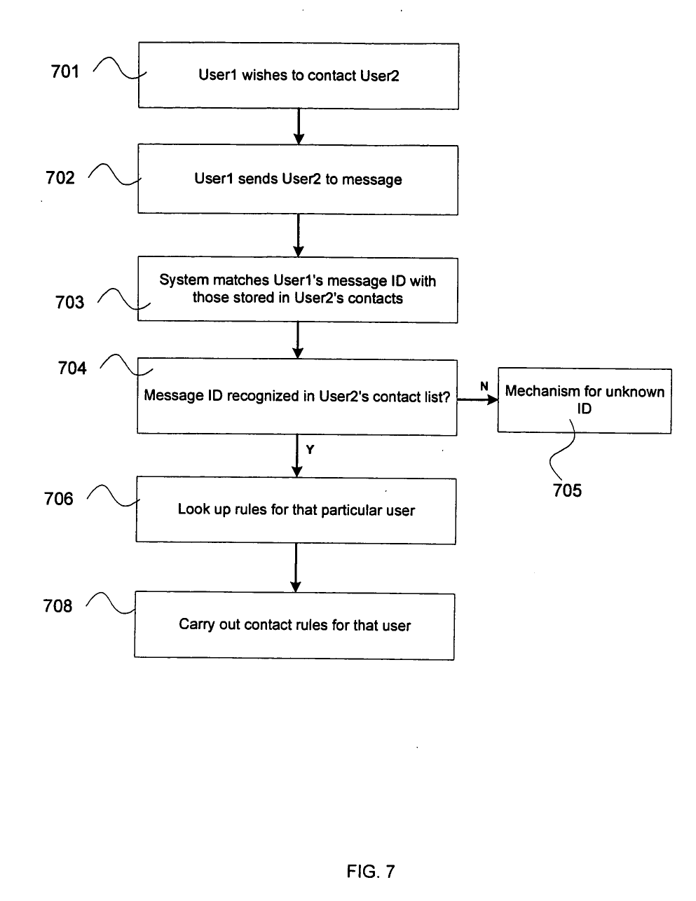

Referring now to FIG. 7, a simplified process in which a contact proxy may be used for text based messaging is shown, based on one embodiment. Initially, user1 wishes to contact user2 701, user1 sends user2 a message 702, based upon user1's message ID address such as the email address 704, if it is not known then the mechanism for an unknown message ID will be used 705, otherwise the rules base for that particular user is looked up 706, and the contact rules are applied 708 as expressed by titles.

In another embodiment, a user provides a title that provides access to a web page based messaging system, through which the user can be contacted. If at any point the user wishes to stop communication with a particular contact, then the title to that contact can be rescinded.

In another embodiment, a digital identity title provides an efficient mechanism for a user to provide information to another party (i.e., loan applications, employment application, medical history, etc.), avoiding the need for continually retyping information.

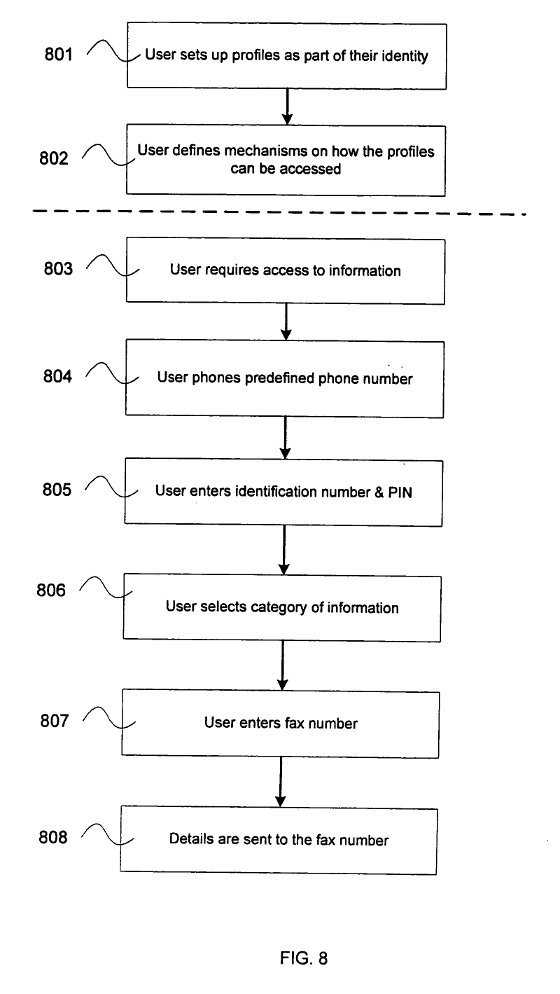

Referring now to FIG. 8, a simplified process in which user information may be provided to another party in a physical form is shown, according to one embodiment. Initially, the user prior to requiring the information sets up profiles 801, for example medical, loan, and employment. The user then defines the allowed mechanism for accessing the information 802. When the user is required to supply information to another party 803, they will phone a predefined phone number, enter a identification number and personal identification number 806. The user then selects the category of the information that is required 806, and enters a destination fax number 807, to which the information profile is faxed 88. In another embodiment email, web pages, or other electronic communication could be used instead of fax and telephone, and the receiving party would receive the information in an electronic form that they could transfer to their systems.

In another embodiment rights may be assigned to other people so that they can manage tasks or accounts on the user's behalf. In this process, the user may issue a title to the other person which will define the rights to access that account or service. For example, booking travel on the user's behalf using the user's travel account, or assigning the rights to use a credit card account for predefined tasks. It should be noted that by assigning these rights the user only has to assign a subset of their rights, compared to systems today in which giving a person your login name and password effectively assigns them all your rights.

The present invention enables a granular definition of identity information as well as granular access to that information. By expressing identity as a set, or collection of discretely defined information, resources, and entities, the present invention provides a much more powerful and extensible identity profile than is available in systems today. For example, titles may be used to represent personal information as well as devices, contracts, certifications, and other resources that make up a user's identity. Varying levels of access to this identity portfolio can then be granted with a high degree of granularity. Identity is simply not information about the user, it is an evolving set of rights that the user possesses.

In another embodiment, an external verification mechanism is defined within in the identity title. Thus when a user presents a title that gives access to an account or service, additional information would need to be provided for validation. (i.e., password, personal identification number, PKI digital signing, or biometric based systems).

In another embodiment, an identity title represents objects and organizations. For example, an identity title could be published for an object that is for sale, and using the title search mechanisms could easily be found. In another embodiment, basic contact information would be provided for non employees of that organization, while for employees an internal contact list could be provided.

If a title refers to an object, that object can be any physical or digital object, and can even include objects defined in processing logic, systems, or software code. Objects can be identified in any number of ways including Digital Object Identifiers (DOI), Object Identifiers (OID), Uniform Resource Identifier (URI), or any of a wide variety of other schemes.

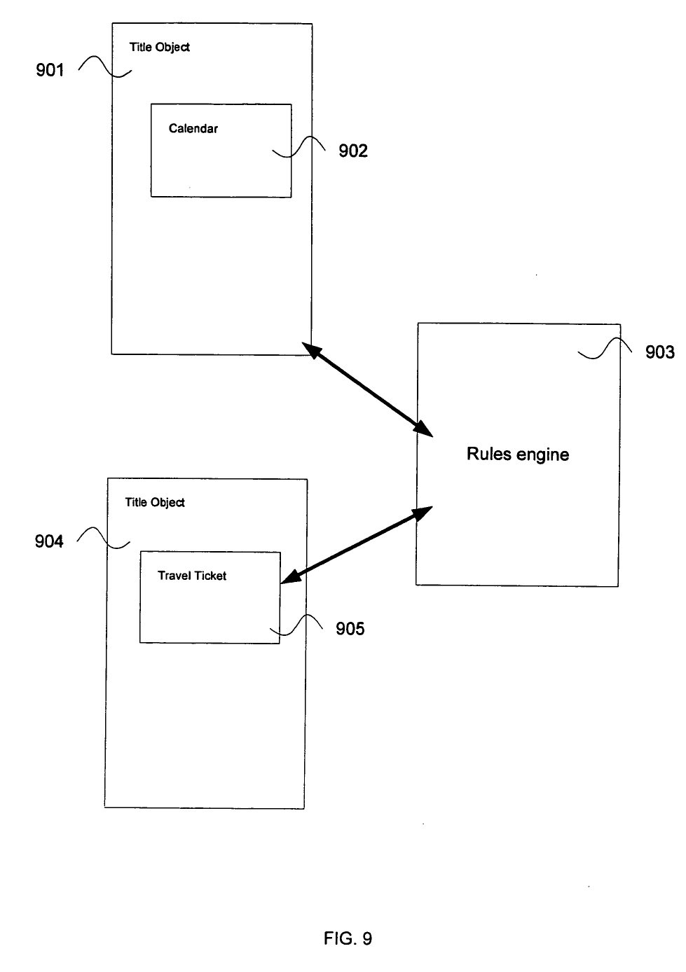

Referring now to FIG. 9, a simplified diagram in which a digital personal assistant is shown, according to one embodiment. A digital personal assistant is a rules based system that maps action between and on those titles. In this example, a user has a title enabled calendar 902 that is monitored by the rules engine 903, and based upon the changes in the calendar the user's travel tickets will be updated 905.

In another embodiment, financial accounts are intelligently managed. For example based upon the balance of defined accounts, funds will be transferred between the accounts, and rules can be applied on how credit cards can be paid off. Other embodiments include federation of services and rescheduling of calendars.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for providing access to identity information corresponding to a first entity, the identity information comprising a plurality of identity components stored in a distributed manner, the method comprising:
generating a first identity access title object which is operable to confer rights to access first selected ones of the identity components to a presenter of the first identity access title object;
transmitting the first identity access title object to a second entity;
facilitating access to the first selected identity components in response to presentation of the first identity access title object by the second entity.

2. The method of claim 1 wherein the first selected identity components comprise fewer than all of the identity components, the method further comprising enabling selection of the first selected identity components by the first entity.

3. The method of claim 1 further comprising generating a second identity access title object which is operable to confer rights to access second selected ones of the identity components to a presenter of the second identity access title object, wherein the second selected identity components comprises a different subset of the identity components than the first selected identity components.

4. The method of claim 1 wherein the plurality of identity components comprises digital information representing any of a personal information associated with the first entity, a contract to which the first entity is a party, a certification associated with the first entity, a credential associated with the first entity, a device associated with the first entity, a physical object associated with the first entity, an online transaction in which the first entity has engaged, a financial account associated with the first entity, financial information associated with the first entity, and medical information associated with the first entity.

5. The method of claim 4 wherein second selected ones of the identity components comprise title objects.

6. The method of claim 4 wherein the plurality of identity components are under control of a plurality of independent entities.

7. The method of claim 1 further comprising receiving an opt-in communication from the first entity indicating agreement by the first entity to participate in a promotion sponsored by the second entity, wherein the first identity access title object is generated only after receiving the opt-in communication.

8. The method of claim 1 wherein a first one of the identity components comprises a contract title object which represents a contract to which the first entity is a party, the contract title object including contract data representing terms and conditions of the contract.

9. The method of claim 8 wherein the contract governs at least one of use by the first entity of a content distribution network, and use by the first entity of a payment mechanism.

10. The method of claim 1 further comprising:
generating an identity score using at least one of the first selected identity components; and
comparing the identity score to a metric specified by the second entity.

11. The method of claim 10 further comprising making a transaction between the first and second entities contingent on comparison of the identity score to the metric.

12. The method of claim 10 further comprising determining whether the second entity is qualified to receive the first identity access title object with reference to second identity information associated with the second entity and at least one rule specified by the first entity.

13. The method of claim 1 wherein an actual identity of the first entity may not be determined by the second entity from the first selected identity components.

14. The method of claim 1 wherein the first identity access title object is generated automatically without intervention by the first entity with references to at least one rule specified by the first entity.

15. The method of claim 1 wherein the first identity access title object is generated in response to input from the first entity, the method further comprising enabling the first entity to specify the first selected identity components.

16. A network for managing identity information for each of a plurality of entities, comprising:
a distributed data store for storing the identity information, the identity information for each entity comprising a plurality of identity components;
an identity management component operable to enable each entity to selectively manage access to subsets of the corresponding identity components by others of the entities;
a title publishing component operable to generate title objects each of which is operable to confer rights to access selected ones of the identity components of an associated entity to presenters of the title object; and
a title resolver component for facilitating access to the selected identity components in response to presentation of the title object.
